(19) United States
(12) Patent Application Publication
(10) Pub. No.: US 2004/0181627 A1
(43) Pub. Date: Sep. 16, 2004

(54) Device and method for recording block status information

(75) Inventors: Yu-Chuan Lin, Sinpu Township (TW); Chun-Chieh Chen, Tainan City (TW); Sheng-Lin Chiu, Caotun Township (TW)

Correspondence Address: BACON & THOMAS, PLLC, 625 SLATERS LANE, FOURTH FLOOR, ALEXANDRIA, VA, 22314

(73) Assignee: RiTek Corporation, Hukou Township (TW)

(21) Appl. No.: 10/720,127

(22) Filed: Nov. 25, 2003

(30) Foreign Application Priority Data
Mar. 13, 2003 (TW) 92105473

(51) Int. Cl. G06F 12/00

(52) U.S. Cl. 711/103

(57) ABSTRACT

A device and method for recording the block status information of a nonvolatile memory is disclosed. An interface unit is used to host the nonvolatile memory so that a processor connected to the interface unit can detect the block status information of the nonvolatile memory through the interface unit to obtain a valid or invalid block address. Then, the valid or invalid block address is temporarily stored in a memory unit until all of the blocks are detected by means of the processor. Finally, the valid or invalid block address temporarily stored in the memory unit is written into the nonvolatile memory.

### BACKGROUND OF THE INVENTION

1. Field of the Invention

The present invention relates to a device and method for recording block status information, and more particularly to a device and method for recording the block status information of a nonvolatile memory.

2. Description of Related Art

The recent development of technologies has popularized portable digital products such as personal digital assistants (PDAs), digital still cameras and USB interface storage device (flash disk). The aforesaid portable products adopt a flash memory to serve as a storage medium. A commercially available NAND-type flash memory usually has one or more faulty blocks. The faulty block will mistake the status of data stored therein. As a result, an error occurs in data access. Thus, it is necessary to prevent the use of faulty blocks while accessing data.

Hence, the user has to identify the faulty block address prior to using the NAND-type flash memory for storing a medium to avoid the faulty blocks being used. In general, the faulty block address is identified only after the product has been assembled in the factory. However, the identification and clearance of the faulty block address require a significant amount of time because a controller of the product has to provide functions for identifying and clearing the faulty blocks due to the post-assembly identification. This remedial process significantly increases the production costs.

### SUMMARY OF THE INVENTION

The primary object of the present invention is to provide a device and method for recording the block status information of a nonvolatile memory so as to reduce the time required for identifying and clearing the faulty block(s) of a flash memory.

Another object of the present invention is to provide a device and method for recording the block status information of a nonvolatile memory so as to simplify the design of the controller and reduce the production costs.

A feature of the present invention is to provide a device for recording the block status information of a nonvolatile memory, which comprises an interface unit electrically connected to at least one nonvolatile memory including a plurality of blocks, each being a basic unit for erasing data of said at least one nonvolatile memory; a processor connected to said interface unit through which the status of a block of said at least one nonvolatile memory is detected to obtain the block status information; and a memory unit connected to said processor for temporarily storing said block status information which is then written into one of said plurality of blocks by means of said processor through said interface unit after the end of the detection.

Another feature of the present invention is to provide a method for recording the block status information of a nonvolatile memory, which comprises the following steps: (A) performing an initialization to set at least one reference value, (B) detecting at least one nonvolatile memory having a plurality of blocks to obtain the status of at least one block which is a basic unit for erasing data of the at least one nonvolatile memory, and (C) writing the detected information into a memory unit until the end of the detection, and then writing the at least one block status information into one of the blocks of the at least one nonvolatile memory.

The aforesaid block status information can be a valid block address or an invalid block address. The interface unit is a housing device, and preferably, it is an integrated circuit (IC) socket. The memory unit can be any storage medium, and preferably, it is a random access memory (RAM).

The nonvolatile memory can be any flash memory, and preferably, it is a NAND-type flash memory. The processor can provide at least one error correction code (ECC) and record the at least one ECC together with block status information to ensure the correct access of the block status information.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram according to the present invention;

FIG. 2 is a flow chart of the first embodiment according to the present invention; and

FIG. 3 is a flow chart of the second embodiment according to the present invention.

### DETAILED DESCRIPTION OF THE PREFERRED EMBODIMENT

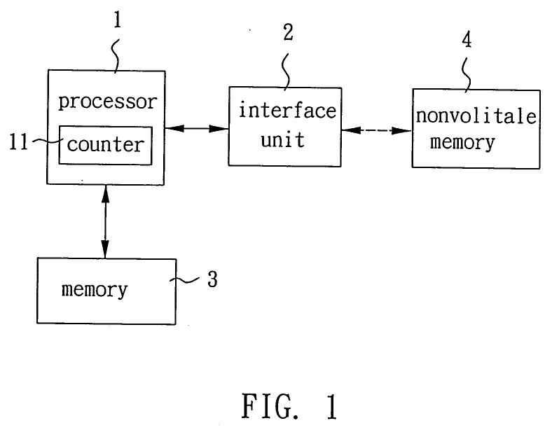

Referring to FIG. 1, a block diagram of a system is illustrated. The present invention comprises a processor 1, an interface unit 2 and a memory unit 3. The processor 1 contains a counter 11. The interface unit 2 is electrically connected to a nonvolatile memory 4. The nonvolatile memory has a plurality of blocks, each of which is a basic unit for erasing data of the nonvolatile memory 4.

In the present invention, the interface unit 2 can be any host device. In the present embodiment, the interface unit is an integrated circuit (IC) socket. The nonvolatile memory 4 can be any flash memory, and preferably, it is a NAND-type flash memory. The memory unit 3 is not specifically defined, which can be an erasable memory or a random access memory (RAM), for example.

The processor 1 is respectively connected to the interface unit 2 and the memory unit 3 for detecting the status of a block of the nonvolatile memory 4 through the interface unit 2 when the nonvolatile memory 4 is hosted in the interface unit 2 to obtain the block status information. The block status information of the nonvolatile memory so obtained is temporarily stored in the memory unit 3 until the detection of all of the blocks of the nonvolatile memory 4. The block status information includes at least one valid block address or at least one invalid block address (that is, faulty block's address). The detection of the blocks of the nonvolatile memory 4 by means of the processor 1 will be described below.

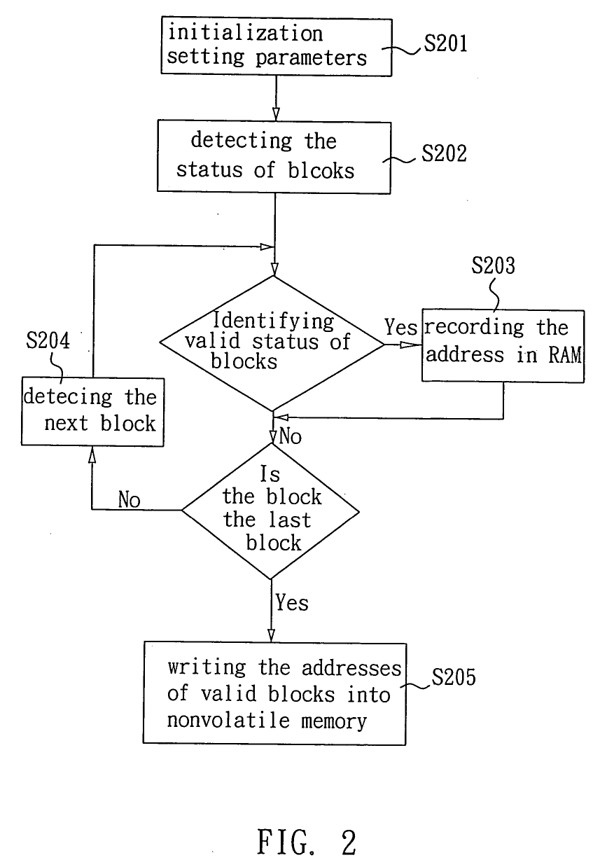

FIG. 2 is a flow chart of the block status information recorded according to the first embodiment of the present invention. Referring to FIGS. 1 and 2 together, the valid block address of the nonvolatile memory 4 is identified prior to assembling the nonvolatile memory 4 into a product (such as a USB interface storage device or memory card). At beginning, the nonvolatile memory 4 is housed in the interface unit 2. An environment initialization begins to set at least one reference value, comprising setting the initial address of a block of the nonvolatile memory 4 to ‘0’ is completed, setting the counter value of the counter 11 to ‘1’, setting the initial address of the memory unit 3 to ‘0’, and calculate the address of the last block of the nonvolatile memory 4 (step S201).

Then, the processor 1 detects the status of a block of the nonvolatile memory 4 through the interface unit 2 to identify whether or not the currently identified block is valid (step S202). If the block is valid, the valid block address is temporarily stored in the memory unit 3 by means of the processor 1. After detecting the status of a block of the nonvolatile memory 4, if the block is valid then the counter value adds 1. The valid block address is then recorded as the block status information (step S203). After recording the block status information, the processor 1 checks whether or not the currently identified block is the last block of the nonvolatile memory 4 by comparing the address of currently identified block with the address of the last block of the nonvolatile memory 4, if the block is not the last one, the processor 1 will check the status of the next block. If the block is invalid in step S202, the processor 1 checks whether or not the currently identified block is the last block of the nonvolatile memory 4 by comparing the address of currently identified block with the address of the last block of the nonvolatile memory 4, and not storing the block address of currently identified block into the memory unit 3. If the detection of the blocks is determined to be not the last block of the nonvolatile memory 4, the next block will be detected (step 204).

If the block detected is determined to be the last block of the nonvolatile memory 4, all the valid memory block addresses temporarily stored in the memory unit 3 will be written into one of the blocks of the nonvolatile memory 4 by means of the processor 1. (Of course, the block for the writing must be valid.) In the present embodiment, the aforesaid one of the blocks is preferably the first block (Block 0). The valid block address is thus written into the first block (step S205) of the nonvolatile memory 4. Nevertheless, the counter value of the counter 11 can be written into the first block by means of the processor 1 so that the manufacturer is able to read the number and the address of the valid blocks of the nonvolatile memory 4 directly. In this connection, the nonvolatile memory 4 is ready for use to reduce the time required for identifying the validity of the blocks of the nonvolatile memory 4 and to simplify the design of the controller.

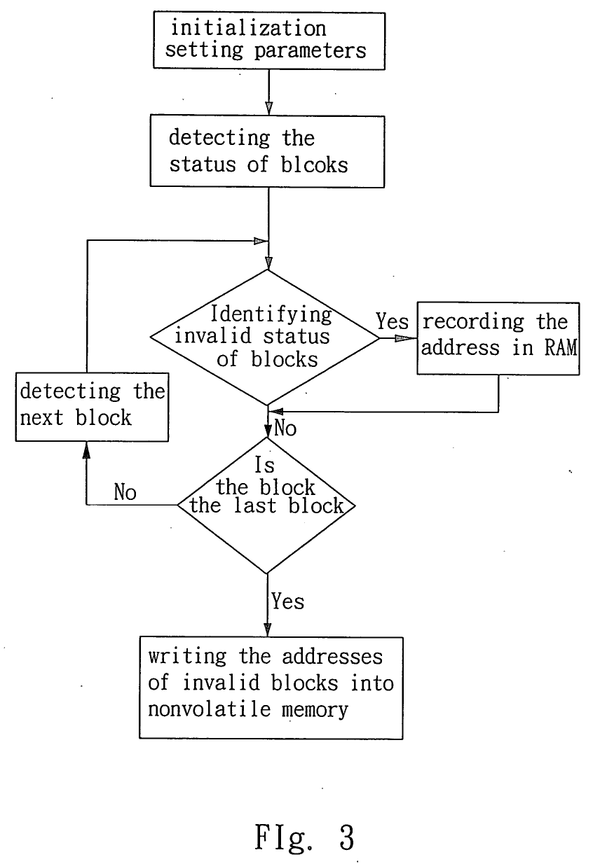

FIG. 3 is a flow chart of the block status information recorded according to the second embodiment of the present invention. The flow chart of this embodiment is similar to that of the first embodiment, except the number and the address of the invalid blocks are collected and written into the first block of the nonvolatile memory.

In addition to the writing of the information about the number and the address of the valid or invalid blocks into the first block, an error correction code (ECC) is provided for the valid or invalid blocks. The ECC is recorded together with block status information so as to enhance the correctness of block status information stored therein. Hence, no error occurs in block status information access.

It is conceivable from the above description that the present invention adopts the processor to read the block information of the nonvolatile memory through the interface unit before assembling the nonvolatile memory to the product so that the number and address of the valid or invalid blocks are obtained. Thus, the present invention can reduce the time required for identifying and clearing the faulty blocks of the flash memory and simplify the design of the controller so as to reduce production costs.

Although the present invention has been explained in relation to its preferred embodiments, it is to be understood that many other possible modifications and variations can be made without departing from the spirit and scope of the invention as hereinafter claimed.

What is claimed is:

1. A device for recording the block status information of a nonvolatile memory, comprising:
an interface unit electrically connected to at least one nonvolatile memory including a plurality of blocks, each being a basic unit for erasing data of said at least one nonvolatile memory;
a processor connected to said interface unit through which the status of a block of said at least one nonvolatile memory is detected to obtain the block status information; and
a memory unit connected to said processor for temporarily storing said block status information which is then written into one of said plurality of blocks by means of said processor through said interface unit after the end of the detection.

2. The device for recording the block status information of claim 1, further comprising a counter for counting the number of the blocks of said at least one nonvolatile memory when said processor detects the status of the blocks of said at least one nonvolatile memory to obtain a counter value so that said processor writes said counter value into said at least one nonvolatile memory after the end of the detection.

3. The device for recording the block status information of claim 2, wherein said counter value is the number of valid blocks or invalid blocks.

4. The device for recording the block status information of claim 1, wherein said recorded block status information includes at least one valid block address.

5. The device for recording the block status information of claim 1, wherein said recorded block status information includes at least one invalid block address.

6. The device for recording the block status information of claim 1, wherein said interface unit is a host device.

7. The device for recording the block status information of claim 5, wherein said host device is an integrated circuit (IC) socket.

8. The device for recording the block status information of claim 1, wherein one of said plurality of blocks is the first block (Block 0).

9. The device for recording the block status information of claim 1, wherein said processor provides at least one error correction code (ECC) and records said at least one ECC together with said block status information to ensure the correct access of the block status information.

10. The device for recording the block status information of claim 1, wherein said memory unit is a random access memory (RAM).

11. The device for recording the block status information of claim 1, wherein said at least one nonvolatile memory is a NAND-type flash memory.

12. A method for recording the block status information of a nonvolatile memory, comprising the following steps:
(A) performing an initialization to set at least one reference value;
(B) detecting at least one nonvolatile memory having a plurality of blocks to obtain the status of at least one block which is a basic unit for erasing data of the at least one nonvolatile memory; and
(C) writing the detected information into a memory unit until the end of the detection, and then writing said at least one block status information into one of the blocks of said at least one nonvolatile memory.

13. The method of claim 12, wherein a counter for counting the number of the detected blocks is further used at step (B) to obtain a counter value to be written into said at least one nonvolatile memory after the end of the detection.

14. The method of claim 12, wherein said at least one reference value comprises the initial address of said nonvolatile memory, the counter value of said counter and the initial address of said memory unit.

15. The method of claim 12, wherein said at least one detected information is at least one valid block address.

16. The method of claim 12, wherein said at least one detected information is at least one invalid block address.

17. The method of claim 12, wherein one of the blocks is the first block (Block 0).

18. The method of claim 12, wherein writing of at least one error correction code (ECC) together with block status information to ensure the correct access of the block status information.

19. The method of claim 12, wherein said at least one nonvolatile memory is a NAND-type flash memory.

20. The method of claim 19, wherein said flash memory is a NAND-type flash memory.

21. The method of claim 12, wherein said memory unit is a random access memory (RAM).
